(19) United States
(12) Patent Application Publication
(10) Pub. No.: US 2007/0245371 A1
(43) Pub. Date: Oct. 18, 2007

(54) Auto-adaptive program distribution system

(75) Inventor: Fabrice Michel Raymond Quinard, Los Gatos, CA (US)

Correspondence Address: THELEN REID BROWN RAYSMAN & STEINER LLP, P. O. BOX 640640, SAN JOSE, CA, 95164-0640, US

(73) Assignee: Terayon Communication Systems, Inc.

(21) Appl. No.: 11/405,847

(22) Filed: Apr. 17, 2006

(51) Int. Cl. H04N 7/18; H04N 5/445; H04N 7/025

(52) U.S. Cl. 725/34; 725/78; 725/46; 725/97

(57) ABSTRACT

An auto-adaptive program distribution system in which content is transmitted from one or more content providers to one or more subscribers each associated with a service group includes an auto-adaptive switch whose inputs is a set of programs from the content providers and whose outputs are grouped into at least two groups, the first of which is dedicated to broadcast programming directed to multiple service groups, and the second of which is dedicated to switched programming sent to one or more of the service groups. The switched programming group includes at least one program selected on an on-demand basis. The auto-adaptive switch is provided with an analysis module which handles the group allocation, and makes its assignments based on statistical analyses performed in accordance with prescribed algorithms which take factors such as seasonal television viewership, seasonal and aberrational events and programming, time of day, week, year, and so forth.

### CROSS-REFERENCE TO RELATE APPLICATIONS

(Not applicable)

### BACKGROUND OF THE INVENTION

1. Field of the Invention

The invention relates to switched broadcast systems.

2. Description of the Related Art

Switched broadcast systems are systems in which content is transmitted from content providers to subscribers on an on-demand basis. This down-stream transmission is conducted in accordance with out-of-band (upstream) requests from the subscribers, who select the content using for example a set-top box having a handheld remote control. Because of bandwidth limitations, it is costly and impractical to transmit to each subscriber of a service group all available content or programs. Instead, what has traditionally been done is for network managers to determine which programs are the most popular, and to send these to all subscribers in all service groups. As for the remaining programs, these are switched in groups and forwarded to the subscribers on an on-demand basis. These group allocations are also manually made by the network manager. A major difficulty that arises is how to make these group assignments efficiently and in a timely manner, given the constant changes in content demand based on numerous factors such as time of day, day of week, season, and aberrational events such as natural disasters and other news-intensive activity.

### BRIEF SUMMARY OF THE INVENTION

The above issues are addressed by the inventive system and method, which in accordance with one aspect provide an auto-adaptive switched program distribution system for distributing content from a plurality of content providers to one or more subscribers each associated with a service group. The system includes first and second gateway devices communicating over a distribution ring by way of which the content is transmitted, and an auto-adaptive switch receiving at an input thereof the transmitted content from the plurality of content providers. The auto-adaptive switch has a plurality of outputs of which at least one is associated with a first content group which is broadcast to multiple service groups, and of which at least another is associated with a second content group which is forwarded to one or more service groups, the second content group including at least one program selected on an on-demand basis. The first and second content groups are automatically determined by the auto-adaptive switch.

In accordance with another aspect of the invention, there is provided an auto-adaptive switch configured to direct content from one or more content providers to one or more subscribers each associated with a service group. The switch includes a plurality of content inputs through which content is received by the switch and a plurality of content outputs through which content is output by the switch. At least one of the content outputs is associated with a first content group which is broadcast to multiple service groups, and at least another of the content outputs being associated with a second content group which is forwarded to one or more service groups and including at least one program which is selected on an on-demand basis. The switch further includes an analysis module configured to assign a first subset of the content from the one or more content providers to the first content group and a second subset of the content from the one or more content providers to the second content group.

In accordance with another aspect of the invention, there is provided a method for dynamically directing content from one or more content providers to one or more subscribers each associated with a service group. The method includes receiving the content from the one or more content providers, automatically assigning a first subset of the received content to a first output and directing the first subset through the first output to multiple service groups and automatically assigning a second subset of the received content to a second output and directing the second subset through the second output to one of the service groups, the second subset including at least one program selected on an on-demand basis.

### BRIEF DESCRIPTION OF THE SEVERAL VIEWS OF THE DRAWINGS

Many advantages of the present invention will be apparent to those skilled in the art with a reading of this specification in conjunction with the attached drawings, wherein like reference numerals are applied to like elements, and wherein:

FIG. 1 is a an architectural diagram of an auto-adaptive switched program distribution system in accordance with the invention; and

FIG. 2 is a block diagram showing the operation of auto-adaptive switch of the invention.

### DETAILED DESCRIPTION OF THE INVENTION

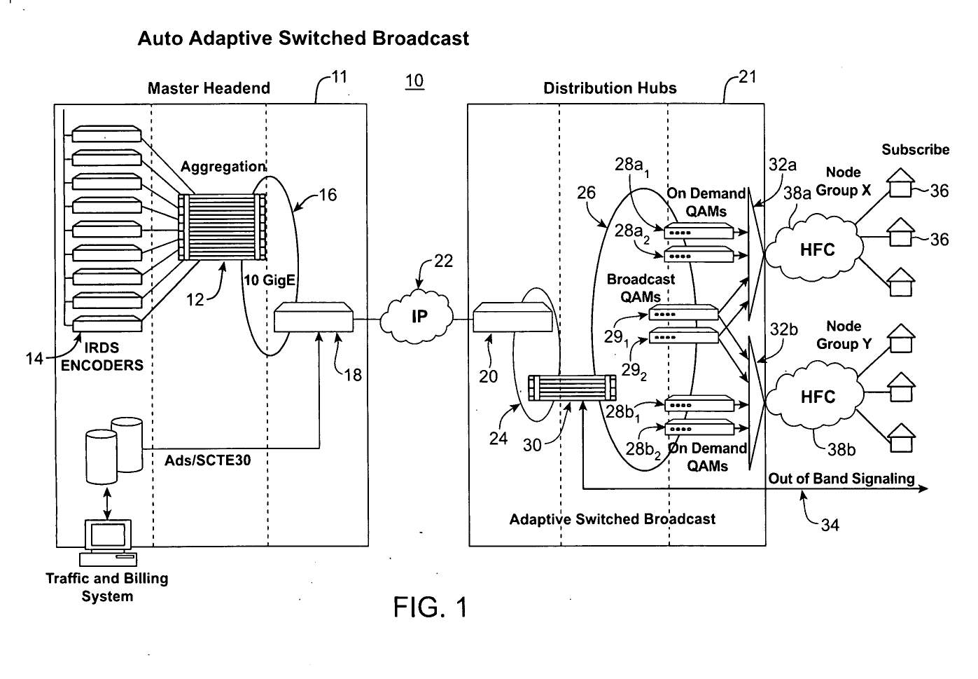

FIG. 1 is an architectural diagram of an auto-adaptive switched program distribution system 10 in accordance with the invention. A master head-end 11 includes a program aggregation device 12 for aggregating signals from a plurality of IRD encoders such as satellite receivers or MPEG encoders 14. A local IP network 16 connects the aggregation device 12, and possibly others like it (not shown) to a first, send IP distribution gateway such as an IP over DWDM transport device 18, which is in communication with a second, receive IP distribution gateway such as an IP over DWDM transport device 20 of a distribution hub 21 by way of an inter-office IP distribution ring 22. Signals are sent to auto-adaptive switch 30, which is an MPEG switch with integrated switch broadcast server, by way of a local IP network 24, and forwarded to quadrature amplitude modulation (QAM) devices, or modulators 28, 29, by way of local IP network 26. One or more RF combiners 32a, 32b combine the signals from the QAM modulators 28, 29 and distribute these signals to subscribers 36 of various service groups X, Y, Z linked by HFC (hybrid fiber-coaxial) networks 38a, 38b.

QAM modulators 28 (that is, 28a₁, 28a₂, 28b₁, 28b₂, and so forth) are designed to deliver on-demand (switched) programming to each service group. QAM modulators 29 (that is, 29₁, 29₂, and so forth), by contrast, are dedicated to broadcast programming. Considering a set of S programs (for example 150) which the system 10 is designed to distribute from master headend 11 to the HFC networks 38 and subscribers, a subset of the S programs, designated P, consists of what has been determined to be the most popular or most requested or watched programs or programs complying with any similar criterion and thus having some preferred status. Broadcast QAM modulators 29 are dedicated to this subset P of most popular programs. Their outputs are transmitted to all of the HFC networks (38a, 38b) so that they reach multiple service groups regardless of subscriber selection. The remaining programs can be classed into a set R containing one or more possibly intersecting sets U which are assigned to on-demand QAM modulators 28a₁, 28a₂, 28b₁, 28b₂, and so forth. Outputs of QAM modulators 29₁, 29₂ are combined with outputs of QAM modulators 28a₁, 28a₂ in RF combiner 32a, and with outputs of QAM modulators 28b₁, 28b₂ in RF combiner 32b. Selections by subscribers 36 are made via for example television remote control terminals (not shown) which transmit the subscriber's selection through the set-top box (STB) (not shown) as OOB (out-of-band) signals directed to auto-adaptive switch 30.

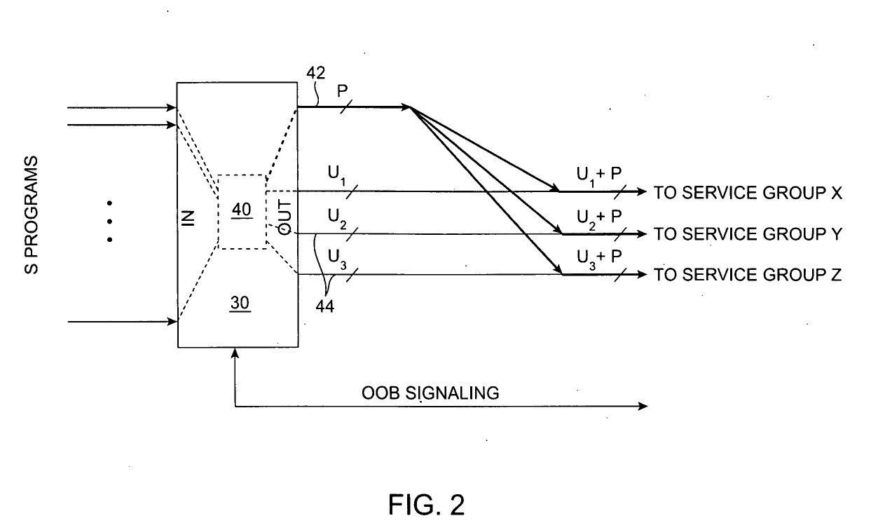

FIG. 2 is a block diagram showing the operation of auto-adaptive switch 30, which serves to manage the shared and combined broadcast QAM modulators 29 in an optimized fashion. In order to accommodate limited bandwidth, auto-adaptive switch 30 is charged with determining the allocation of programming in the subsets P and U of program set S. In other words, auto-adaptive switch 30 determines which are the most popular programs P, to which QAM modulators 29 are dedicated, and which are the less popular programs U, to which QAM modulators 28 dedicated. It will be appreciated that criteria other than popularity are contemplated. The determination of popularity in this exemplary case is preferably based on an analysis of subscriber selections over time, for example a statistical analysis, as these selections are received from OOB signals input to auto-adaptive switch 30. Generally, the intent is to keep as many on-demand (switched) channels available as possible, across all the service groups served by the same broadcast QAM modulators. This does not necessarily mean that the most watched program will always be in the broadcast QAMs.

Auto-adaptive switch 30 receives S programming signals at its input, makes P and U subset assignments in accordance with suitable analysis algorithms performed by analysis module 40, and outputs at a first output 42 the designated P programs, and outputs at a plurality of second outputs 44 the designated U programs. Programs P and U are then combined and each set U+P is transmitted to a service group X, Y, Z etc. that is associated with an HFC network 38, such as network 38a or network 38b in FIG. 1. The result is that the P programs are broadcast to multiple service groups 38, while the U programs are forwarded to one or more of the service groups on an on-demand basis.

It will be appreciated that program content of subsets P and U is dynamically determined and constantly changes based on analysis algorithms performed in an automated fashion by switch 30, and more particularly, by analysis module 40 of the switch. Refreshing of the program allocation between the subsets P and U can be performed on a regular basis—for instance, hourly, daily, weekly, or monthly, or when no more switched channels are available in any given service group, or on any time schedule that is deemed to be optimal for taking into account factors such as seasonal viewership of television programming, sporting event scheduling, weekday, weekend or holiday usage traffic, and so on. It can alternatively or in addition be performed on demand, based on manager requests from master headend 11 for example, which requests could be used to trigger and/or modify the recalculation algorithms of analysis module 40 of the switch 30.

Let's assume 3 service groups X, Y, Z, served respectively by the group of programs U₁+P, U₂+P, U₃+P. The group S consists of the total number of programs Sn that can be watched by any subscriber on the service groups X Y and Z.

The group of programs P is common to all 3 service groups. The groups of programs U₁, U₂, U₃ consist of the programs that are being watched in each service group, and not already present in the group P.

Let's assume that the group P can deliver Pn number of programs, and the groups U₁, U₂, U₃, Un number of programs.

Based on the above description, it will be understood that in order for the system to be statistically efficient over a traditional broadcast mode of delivery, Pn+Un<<Sn

The analysis module 40 classifies and sorts the Sn programs available to the subscribers by order of popularity across all three service groups X, Y and Z. In other words, for each Sn programs of the group S, the analysis module 40 counts the total number of subscribers watching each program. The analysis module 40 always assigns the maximum possible number of programs Pn to the group P. The Pn number of programs with the highest number of viewers are allocated to the group P, and the remaining watched programs are allocated to the groups U₁, U₂, and U₃. Note that the programs in groups U₁, U₂ and U₃ may be different but not necessarily.

The above are exemplary modes of carrying out the invention and are not intended to be limiting. It will be apparent to those of ordinary skill in the art that modifications thereto can be made without departure from the spirit and scope of the invention as set forth in the following claims.

1. An auto-adaptive program distribution system for distributing content from a plurality of content providers to one or more subscribers each associated with a service group, the system comprising:
first and second gateway devices communicating over a distribution ring by way of which said content is transmitted; and
an auto-adaptive switch receiving at an input thereof said transmitted content from said plurality of content providers, said auto-adaptive switch having a plurality of outputs of which at least one is associated with a first content group which is broadcasted to multiple service groups, and of which at least another is associated with a second content group which is forwarded to one or more service groups, the second content group including at least one program selected on an on-demand basis, the first and second content groups being automatically determined by the auto-adaptive switch.

2. The system of claim 1, wherein the auto-adaptive switch includes an analysis module which assigns content to the first and second content groups based on number of viewers.

3. The system of claim 1, wherein the output dedicated to the first content group is combined with the output dedicated to the second content group, said combined outputs being provided to each service group.

4. An auto-adaptive switch configured to direct content from one or more content providers to one or more subscribers each associated with a service group, the switch comprising:
a plurality of content inputs through which content is received by the switch;
a plurality of content outputs through which content is output by the switch, at least one of the content outputs being associated with a first content group which is broadcasted to multiple service groups, at least another of the content outputs being associated with a second content group which is forwarded to one or more service groups and including at least one program which is selected on an on-demand basis; and
an analysis module configured to assign a first subset of the content from the one or more content providers to the first content group and a second subset of the content from the one or more content providers to the second content group.

5. The switch of claim 4, wherein the analysis module assigns content to the first and second content groups based on number of viewers.

6. A method for dynamically directing content from one or more content providers to one or more subscribers each associated with a service group, the method comprising:
receiving the content from the one or more content providers;
automatically assigning a first subset of the received content to a first output and directing the first subset through the first output to multiple service groups;
automatically assigning a second subset of the received content to a second output and directing the second subset through the second output to one of the service groups, the second subset including at least one program selected on an on-demand basis.

7. The method of claim 6, wherein automatically assigning is performed based on number of viewers.

8. A system for dynamically directing content from one or more content providers to one or more subscribers each associated with a service group, the system comprising:
means for receiving the content from the one or more content providers;
means for automatically assigning a first subset of the received content to a first output and directing the first subset through the first output to multiple service groups; and
means for automatically assigning a second subset of the received content to a second output and directing the second subset through the second output to one of the service groups, the second subset including at least one program selected on an on-demand basis.

9. The method of claim 8, wherein automatically assigning is performed based on number of viewers.
